(19) United States
(12) Patent Application Publication
(10) Pub. No.: US 2014/0172954 A1
(43) Pub. Date: Jun. 19, 2014

(54) SYSTEM AND METHOD FOR PRIVATE CLOUD INTRODUCTION AND IMPLEMENTATION

(71) Applicant: UNISYS CORPORATION, Blue Bell, PA (US)

(72) Inventors: Michael A. Salsburg, Phoenixville, PA (US); Gerald A. Hupperts, Roseville, MN (US); Mark Hodapp, Westford, MA (US)

(73) Assignee: UNISYS CORPORATION, Blue Bell, PA (US)

(21) Appl. No.: 13/716,409

(22) Filed: Dec. 17, 2012

(51) Int. Cl. H04L 29/08; H04L 29/06

(52) U.S. Cl. CPC H04L 67/02; H04L 67/42
USPC 709/203

(57) ABSTRACT

Systems and methods are disclosed herein to a method of introducing and acclimating an enterprise with a cloud comprising: hosting a cloud by provisioning virtual machines using the resources of a zero touch point device with a cloud management environment; installing, by a computer, the cloud on an enterprise server; evaluating, by a computer, an inventory of applications to be hosted by the enterprise server on the cloud; defining, by a computer, application tiers for the evaluated applications; classifying, by a computer, the applications in the inventory of applications into the defined application tiers; migrating, by a computer, at least one non-production application of the non-production application tier to the cloud; migrating, by a computer, at least one production application of the production application tier to the cloud; and migrating, by a computer, at least one mission critical application of the mission critical application tier to the cloud.

### TECHNICAL FIELD

The present invention generally relates to cloud computing, and more particularly to a system and method to introduce and integrate an enterprise with a private cloud.

### BACKGROUND

The term “cloud computing” generally refers to a model that makes computing resources available over a network as services. A “cloud” is a set of computing resources, such as computer hardware, data storage, networks, applications, services, and interfaces, that allow for computing to be delivered as a service. A cloud can be a private cloud, a public cloud, or a hybrid cloud that combines both public and private clouds. A private cloud typically includes a data center or proprietary network that provides computing services to a group of people, an organization, a business, or another entity. A private cloud may be located within an organization's private network or within a private space dedicated to an organization within a cloud vendor data center. Any cloud may be configured as a web service that allows users to manage computing resources hosted by the cloud via a web interface.

In a cloud, computing resources are provided to a user on demand and in various sizes and configurations. For example, a user may utilize a cloud for storing a small amount of data or for hosting processor intensive software applications. A user can request additional resources on demand and de-allocate resources when they are no longer required. This flexibility and elasticity has made cloud computing attractive to many businesses and information technology (IT) professionals. In addition to this flexibility and elasticity, cloud computing can enable an organization to reduce capital expenses normally allocated to IT infrastructure.

Public clouds, which are created and managed by third party cloud providers, are attractive to some enterprises because the third party cloud providers manages the datacenter, which in turn, allows an enterprise to cut technology costs. However, various barriers prevent enterprises from entering into service contracts with public cloud providers. For example, data may be too large to be sent over a wide area network, or data may be too sensitive or confidential to trust to a third party. Thus, a private cloud managed by the enterprise itself provides many of the resource allocation benefits to the enterprise without the worry of losing or sharing sensitive data. If an enterprise possesses data that is to large or too sensitive to be sent to a public cloud, the enterprise may need to build a private cloud to reap the benefits of a cloud.

While having a private cloud may provide benefits and cost savings, enterprises may still hesitate to build a private cloud because creating a cloud from the ground up seems like a daunting task either because the task of building a private cloud seems too costly or because the task of building a private cloud seems too technically complex. Moving to a private cloud also represents a huge change in everyday operations for an enterprise, which may scare some enterprises away from building a private cloud. These perspectives may have merit, but the benefits of a private cloud should be made available to any organization, big or small.

Information services companies may provide assistance, training, and technological consulting to help enterprises create their own private cloud. These programs may demonstrate benefits and savings for the enterprise However, the task of setting up the private cloud, even with the assistance of an information services company, may still seem daunting and not worth the time and effort.

Thus a method to introduce and acclimate a customer to the private cloud is desired so that the task of building a private cloud does not seem so daunting,

### SUMMARY

The systems and methods described herein attempt to overcome the drawbacks discussed above by providing progressive and gradual steps to introduce and acclimate an enterprise to a private cloud. The steps begin by bringing in a portable computer capable of demonstrating a secure private cloud to the enterprise. The portable computer demonstrates all the features and benefits of the private cloud without requiring the enterprise to provide any computing resources or connect the portable computer to any existing touch points, such as networks, servers or client devices. Once the benefits of the private cloud are demonstrated, an information systems company assists the enterprise in the process of discovering and evaluating current touch points and cloud servers. The information systems company may also assist in deploying the private cloud across all sectors of the enterprise. The gradual steps of deployment begin by creating a small private cloud, then moving towards adding more touch points and applications until eventually the private cloud runs mission critical applications. These gradual steps allow the enterprise to become familiar and comfortable with the private cloud over time, rather than drastically changing business operations in a “big bang” scenario.

In one embodiment, a method of introducing and acclimating an enterprise with a cloud comprises: hosting, by a zero touch point computer system, a cloud by provisioning virtual machines using the resources of the zero touch point device with a cloud management environment; installing, by a computer, the cloud on an enterprise server, wherein the cloud is accessible to a limited number of client computers through a network; identifying, by a computer, all client computers connected to the enterprise server through the network; evaluating, by a computer, an inventory of applications to be hosted by the enterprise server on the cloud; defining, by a computer, application tiers for the evaluated applications, wherein the defined application tiers comprise a non-production application tier, a production application tier, and a mission critical application tier; classifying, by a computer, the applications in the inventory of applications into the defined application tiers; integrating, by a computer, at least one of the identified client computers to the cloud based on the evaluated applications of the enterprise server; migrating, by a computer, at least one non-production application of the non-production application tier to the cloud; integrating, by a computer, all the identified client computers to the cloud based on the evaluated applications of the enterprise server; migrating, by a computer, at least one production application of the production application tier to the cloud; and migrating, by a computer, at least one mission critical application of the mission critical application tier to the cloud.

In another embodiment, a method of introducing and acclimating an enterprise with a cloud comprises: hosting, by a zero touch point computer system, a cloud by provisioning virtual machines using the resources of the zero touch point device with a cloud management environment; installing, by a computer, the cloud on an enterprise server, wherein the cloud is accessible to a limited number of client computers through a network; evaluating, by a computer, an inventory of applications to be hosted by the enterprise server on the cloud; defining, by a computer, application tiers for the evaluated applications, wherein the defined application tiers comprise a non-production application tier, a production application tier, and a mission critical application tier; classifying, by a computer, the applications in the inventory of applications into the defined application tiers; migrating, by a computer, at least one non-production application of the non-production application tier to the cloud; migrating, by a computer, at least one production application of the production application tier to the cloud; and migrating, by a computer, at least one mission critical application of the mission critical application tier to the cloud.

In another embodiment, a cloud system in an enterprise comprises a zero touch point device configured to host a first private cloud for demonstration purposes; a cloud server connected to a plurality of client devices through a network configured to host a second private cloud, wherein the second private cloud is similar to the first private cloud and the second private cloud comprises more computing resources than the first private cloud; and a cloud creation computer system connected to the cloud server configured to: install the second private cloud on the cloud server; identify all the client computers connected to the cloud server through the network; evaluate an inventory of applications to be hosted by the cloud server on the second private cloud; define application tiers for all of the discovered applications, wherein the defined application tiers comprise a non-production application tier, a production application tier, and a mission critical application tier; classify the applications in the inventory of applications into the defined application tiers; integrate at least one of the identified client computers to the cloud based on the evaluated applications of the cloud server; migrate at least one non-production application of the non-production application tier to the second cloud; migrate at least one production application of the production application tier to the second cloud; and migrate at least one mission critical application of the mission critical application tier to the second cloud.

Additional features and advantages of an embodiment will be set forth in the description which follows, and in part will he apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings constitute a part of this specification and illustrate an embodiment of the invention and together with the specification, explain the invention.

FIG. 1 illustrates a cloud operating environment within an enterprise according to an exemplary embodiment.

FIG. 2 illustrates a set of progressive and graduals stages to acclimate a enterprise with a private cloud according to an exemplary embodiment.

FIG. 3 illustrates a set phases included in the second stage of the method illustrated in FIG. 2 according to an exemplary embodiment.

### DETAILED DESCRIPTION

Reference will now be made in detail to the preferred embodiments, examples of which are illustrated in the accompanying drawings. The embodiments described above are intended to be exemplary. One skilled in the art recognizes that numerous alternative components and embodiments that may be substituted for the particular examples described herein and still fall within the scope of the invention.

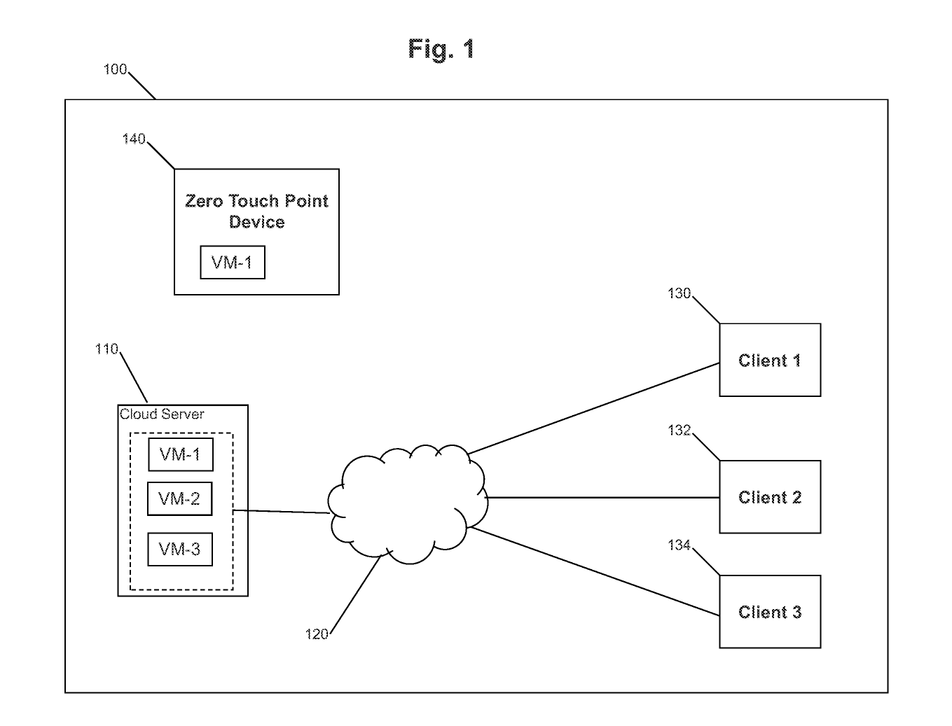

FIG. 1 illustrates a cloud operating environment within an enterprise, in accordance with certain exemplary embodiments. As shown in FIG. 1, an enterprise 100 includes a cloud server 110 connected to a network 120. The cloud server 110 may be one server, a group of servers, a host computer, or any collection of computing hardware. The cloud server 110 hosts a private cloud within the enterprise 100. The cloud server 110 can include different capabilities, features, attributes, and industry certifications. For example, the cloud server 110 may offer Infrastructure-as-a-Service (IaaS), Platform-as-a-Service (PaaS), software-as-a service (SaaS), or any other type of cloud. For another example, the cloud server 110 may offer virtual servers or physical servers and virtual servers.

Although a plurality of virtual machines are illustrated in the cloud server 110, exemplary technology attributes of the cloud server 110 may include, but are not limited to, whether the cloud server 110 provides only virtual machines or virtual resources to host computing workloads, supported operating systems (OS), supported Database Management Systems (DBMS), and application development environments. Exemplary technology features for the cloud server 110 may also include an underlying server, storage, a network, and load balancer hardware; dynamic scale-in, scale-out, scale-up, and scale-down capabilities; and data protection in motion (DIM) and data protection at rest (DAR) for multi-tenant shared environments. Additional cloud capabilities that may be identified in a cloud profile include, but are not limited to, resource demand forecasting for business applications, dynamic business service directory, end to end business service transaction monitoring, alerting, event logging, auto-incident generation, and self service console, to name a few. One of ordinary skill in the art having the benefit of the present disclosure would appreciate that many other technology attributes other that those mentioned above may be included in a cloud without departing from the scope and spirit of the present invention.

The network 120 may include an internet connection, LAN, WAN, or other type of network. Because the cloud server 110 hosts a private cloud, the network is preferably a LAN. The network 120 may also include firewalls, SSL encryptions, etc. The servers and computers making up the cloud server 110 may be connected to the network 120 through an Ethernet port, a wireless network antenna, a Bluetooth receiver, or any other type of network used to connect host and client computers. The network 120 may be connected to more than one cloud or more than one server, although only the cloud server 110 is illustrated as connected to the network 120 in FIG. 1.

The cloud server 110 provides computing resources as a service to client devices 130, 132, 134 through the network 120. The client devices 130, 132, 134 may be personal computers, other servers, smart phones, personal data assistances, tablets, or any other type of computer device capable of network connection. The cloud server 110 allocates computer resources to the client devices 130, 132, 134 on demand. For example, the first client device 130 may request a first virtual appliance included in a first virtual machine VM-1. The cloud server 110 allocates computing resources based on the type and scope of the virtual appliance requested by the first client device 130. For example, the cloud server 110 allocates less computing resources of the cloud server 110 for light processing applications. If the virtual appliance requires heavier processing, the cloud server 110 may provide more computing resources. The amount of resources provided to the client devices 130, 132, 134 is scalable when the cloud server 110 is implemented as a cloud.

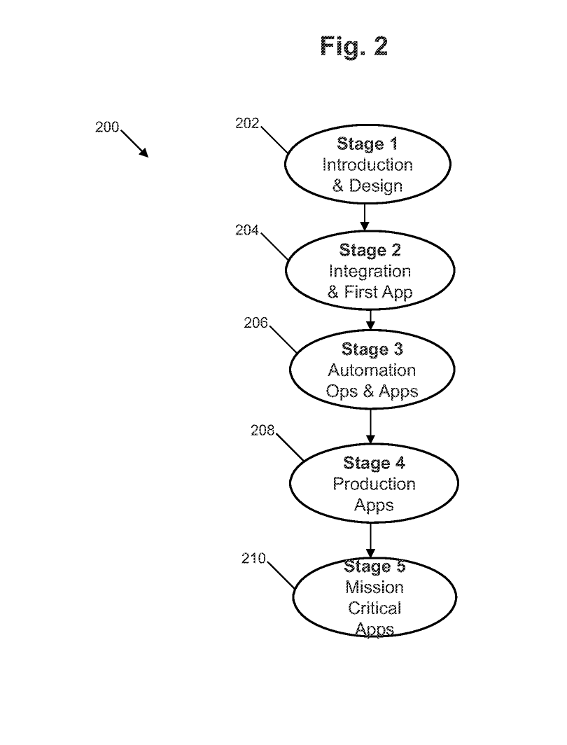

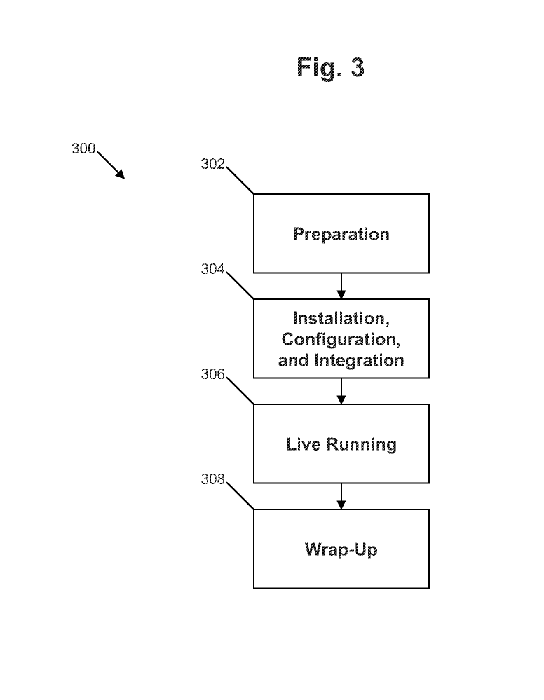

The enterprise 100 may also have a zero touch point device 140. The zero touch point device 140 demonstrates a fully functioning private cloud on a system with limited resources because the zero touch point device 140 initially connects to no other touch points, such as client computers or networks owned and operated by the enterprise 100. The zero touch point device 140 may be a device given to the enterprise 100 by an information systems company, which sells cloud environments and assists in the creation of a cloud. The information systems company may provide the zero touch point device 140 during an introductory stage of the creation of the private cloud, or before the enterprise 100 decides to create a private cloud on the cloud server 110. The proper use of the zero touch point device 140 will be discussed in detail below with reference to FIGS. 2-3.

The zero touch point device 140 may be any type of computing device, such as a server or a portable computer. The zero touch point cloud 140 may be better suited as a portable computer so that the information services company may introduce and demonstrate the private cloud to multiple potential customers using the same zero touch point device 140.

The zero touch point device 140 may assist in the creation of the private cloud. Initially, the zero touch point device 140 may not connect to any network or client devices, not even the Internet, during a trial period. The zero touch point device 140 initially does not connect to any enterprise 100 controlled touch points to remove any enterprise 100 anxiety. In other words, running a private cloud on the zero touch point device 140 poses no risk of long term commitments or malware to the enterprise 100. In later stages of forming a fully implemented private cloud, the zero touch point device 140 connect to the network 120, discover touch points on the network 120, evaluate applications, and help in the design and creation of the private cloud. In this sense, the zero touch point device 140 may become a cloud creation computer system in later stages of the creation of the private cloud on the cloud server 110. In some embodiments, the zero touch point device 140 may not perform the functions of a cloud creation computer system, and another computer system connects to the network 120 to assist in the design of the private cloud.

The zero touch point device 140 may be a portable computer system. For example, the portable computer may host an exemplary private cloud. The portable computer may include portals and cloud management services that demonstrate the functions of a fully implemented private cloud. The resources of the portable computer may be limited, so the zero touch point cloud 140 may not have as many resources to allocate as many applications as a fully functioning private cloud, such as the private cloud 110. So, the zero touch point device 140 merely emulates a workload server using the limited functions and resources of the zero touch point device 140. However, the features and benefits of the private cloud are demonstrated through the zero touch point device 140.

FIG. 1 illustrates a private cloud after complete deployment to the cloud server 110. The deployment of the private cloud according to the exemplary embodiments has several stages, and the enterprise 100 does not deploy a full feature private cloud immediately after entering a service contract with an information systems company. The deployment of the private cloud is generated by gradual and progressive steps to familiarize operations people and IT systems managers with the private cloud. Each of these progressive steps will be discussed in detail with reference to FIG. 2.

FIG. 2 illustrates a five stage method 200 for introducing and deploying a private cloud. Each stage of the method 200 may have multiple phases, for example stage two 204 has four phases, which are illustrated in FIG. 3.

Referring to FIGS, 1 and 2, in stage one 202 of the five stage method, a private cloud is introduced and demonstrated on the zero touch point device 141). An information services company may provide the zero touch point device 140 to the enterprise 100 to generate interest in a fully functioning private cloud hosted by their own equipment. As discussed above, the zero touch point device 140 may execute an exemplary version of a private cloud hosted by the resources of the zero touch point device 140. The private cloud hosted by the zero touch point device 140 may be a “lite” version of a fully implemented private cloud, and as such, the zero touch point device 140 may only be able to a limited number of virtual machines, or run only a limited number of virtual applications and appliances. However, the functions and benefits of the private cloud may be demonstrated through the zero touch point device 140.

The zero touch point device 140 given to the enterprise 100 in stage one 202 demonstrates the value and function of the private cloud without any enterprise 100 investment or commitment. The deployment of the zero touch point device 140 requires no set up, and is configured to work “out-of-the-box.” More importantly, the zero touch point device 140 demonstrates the private cloud without requiring enterprise 100 provided touch points or equipment, such as a network connection, servers, or client devices. The enterprise 100 tries the private cloud hosted by the zero touch point device 140 without risking any computing equipment or signing any binding service contracts. For example, the zero touch point device 140 hosts virtual machines to demonstrate the allocation of resources within the private cloud. Also, the zero touch point device 140 demonstrates a cloud management environment for cloud customization. The zero touch point device 140 may further include training and marketing videos and documentation to generate even more interest. By trying and using the private cloud on the zero touch point device 140, the enterprise 100 hopefully becomes excited about the private cloud and begins to formulate use cases for the private cloud in full deployment.

After stage one 202, and if the enterprise 100 continues to have interest in creating a private cloud, the five stage method 200 continues to the stage two 204. In stage two 204, the enterprise 100 is asked to provide a server, some licenses, a limited number of client devices, and a group of actors willing to participate in the private cloud of stage two 204. In this way, the number of touch points provided by the enterprise 100 is still limited, and the trial period continues on resources provided by the enterprise 100. The actors involved in stage two 204 include a corporate sponsor, IT strategists, cloud administrators, and cloud users, among potentially other actors. The corporate sponsor may be a senior manager championing the enablement of cloud computing for the enterprise 100, the IT strategists may be members of a strategy team responsible for designing the cloud architecture, the cloud administrators may be administrators who set up and maintain the cloud management environment, and the cloud users may be selected developers and IT administrators who commission and decommission servers.

In some cases, the zero touch point device 140 has enough resources to host multiple virtual machines and automate the applications selected for this trial period of stage two 204. As such, the zero touch point device 140 may connect to the enterprise's 100 network and host the private cloud created for stage two 204. In this case, the enterprise 100 does not need to provide a server, and the enterprise 100 provides only a limited number of touch points. However, the scale of stage two 204 probably requires the heavy resources normally provided by servers.

To limit the scope of stage two 204, the private cloud of stage two 204 implements well defined templates and artifacts, which the information systems company developed previously. These templates and artifacts execute the private cloud of stage two 204 in an efficient and low cost manner. For example, the enterprise 100 may select a well-defined application known to function efficiently on the private cloud during stage two 204. The application selected for stage two 204 may have pre-defined configurations and settings for fast installation and efficient demonstration of the private cloud.

Stage two 204 may have four phases 300, which are illustrated in FIG, 3. Referring to FIGS. 2 and 3, phase one 302 involves planning and preparation. Phases one 302 identifies all touch points and all computing resources that will ultimately be dedicated to the private cloud. The private cloud forms through gradual steps, so planning also involves generating tangible steps that build toward a fully implemented private cloud. Phase one 302 also involves specifying a small portion of all of the computer resources owned by the enterprise to create the stage two private cloud. In this way, only a small portion of the computing resources owned by the enterprise are dedicated to the stage two private cloud, while the remaining computing resources owned by the enterprise may remain dedicated to their current tasks and processes. The information systems company may provides a detailed overview of the stage two private cloud during phase one 302. Also, the information systems provides training and preparation materials to the enterprise during phase one 302.

Phase two 304 includes on site installation of the stage two private cloud. Once the stage two private cloud has been installed on the specified computer resources allocated for the stage two private cloud, the stage two private cloud is integrated with the designated applications for stage two 204. The cloud creation computer system may configure the stage two private cloud and the allocated cloud server to execute the designated applications for the stage two private cloud. The cloud creation computer system performs the process of installing, configuring, and integrating the stage two private cloud in a relatively short amount of time because only a limited set of computer resources and only a few applications are to be configured and integrated during stage two 204. For example, this process may take less than two days before live running of the stage two private cloud.

After the cloud creation computer system installs, configures, and integrates the stage two private cloud on the cloud server, the stage two private cloud becomes available to the actors selected for stage two 204 in phase three 306. The stage two actors interact with the stage two private cloud by requesting virtual machines, configuring the cloud management environment, and running applications on the stage two private cloud. During phase three 306, the information systems company may provide consultation and support to the enterprise as the enterprise begins to begins using and learning about the private cloud. For example, the information systems company may administer additional training sessions, technical sessions about the private cloud, discuss user roles within the private cloud, and other support sessions to assist the enterprise in acclimating to the private cloud.

After the enterprise is given an adequate amount of time to use the cloud, phase four 308 begins. Phase four 308 may be a wrap-up phase. For example, a computer system may administer questionnaires to the stage two actors about the stage two private cloud. The enterprise may use this wrap-up phase to suggest desired changes to the private cloud. Also, the enterprise may decide to end their relationship with the information services company if the enterprise feels that a private cloud does not fit their individual needs.

Referring again to FIG. 2, after the completion of all four phases of stage two 204, if the enterprise decides to proceed with the creation of a hilly implemented private cloud, the process 200 continues to stage three 206. In stage three 206, the stage two private cloud may be expanded into a pilot private cloud. In some cases, stages one 202 and two 204 may be skipped, if the enterprise has already determined to create a private cloud.

In stage three 206, the cloud creation computer explores the cloud network and discovers all of the touch points of the enterprise so that the cloud can integrate into the enterprise architecture. The cloud creation computer system provides a number of services to discover the enterprise's environment, applications, workloads, pain points, expectations, and business goals. The cloud creation computer system used to explore and discover the enterprise's architecture may be the zero touch point device or the server that implements the stage two private cloud, or the cloud creation computer system may be another server or group of servers connected to the enterprise's network.

During stage three 206, many of the limitations and restrictions to the stage two private cloud are removed. The cloud creation computer system designs a private cloud best suited for the cloud server available using the data gathered while exploring all the enterprise touch points. While the cloud creation computer system explores the touch points, the private cloud may still have limited accessibility to the network. Also, the pilot private cloud of stage three 206 may not include all touch points of the enterprise. However, the cloud creation computer system discovers all of the enterprise touch points to define how the private cloud will be integrated into the enterprise's architecture.

During the pilot program of stage three 206, the cloud server performs, automates, and makes available a small number of applications through the private cloud. The number of applications executed in the pilot program may be more than the number of applications executed in the stage two private cloud, but the cloud server does not execute production and mission critical applications during stage three 206.

To create the pilot private cloud, the cloud creation computer system performs a number of processes, which may he asynchronous, corresponding to the enterprise's touch points. The cloud creation computer system defines an infrastructure for the private cloud, migrates applications into the private cloud, defines roles, identities cloud service approval processes, and integrates with IT service management. Each of these processes will he discussed in more detail below.

During infrastructure definition, the cloud creation computer system defines infrastructure tiers for application use cases. For example, the tiers may be divided into development and testing applications, production applications, mission critical applications, and sensitive or restricted applications, among other possible tiers. Once the tiers have been defined, the cloud creation computer system specifies security requirements for each tiers, storage requirements for each tier, and connectivity requirements for each tier, such as virtual local area networks, Internet access, and intranet access.

During application migration, the cloud creation computer system evaluates an inventory of applications. Specific requirements for each evaluated application are determined, such as virtualization requirements, storage requirements, service-level agreements, isolation and security requirements, network requirements, and capacity planning requirements.

During role definition, the cloud creation computer system defines roles and privileges for groups such as cloud administrators, cloud operators, tenant administrator, tenant operator, and cloud users.

During cloud service approval identification, the cloud creation computer system discovers the current approval process for provisioning infrastructure resources. The process of provisioning infrastructure resources may he redesigned so that automation of resource allocation is leveraged. Thus, the cloud server provides virtual machines more quickly when requested.

Finally, during IT service management integration, the cloud creation computer system integrates with IT service management processes, such as incident management, problem management, configuration management, asset management, performance and capacity management. As the cloud management automation proceeds, it can automatically update all of these IT management systems that are used to manage the non-cloud resources in the datacenter. For example, the commissioning of a new virtual machine as a service could include automatic updating of the configuration management processes. Another example is the gathering of real-time information that can be used when service interruptions occur. Using the information gathered, the cloud creation computer system may reconfigure the private cloud for better performance and fewer service interruptions.

During the pilot, the number of actors using the private cloud may also increase from stage two 204. For example, the pilot private cloud of stage three 206 may be a multi-tenant private cloud. Concurrently, the cloud server may receive more service catalog definitions so that more virtual machines may be provisioned. Also, the cloud server may host more applications through the private cloud in stage three 206 than in stage two 204.

After the successful completion of phase three 206, the cloud server may begin to host a full production private cloud in stage four 208. Production applications, as defined by the tiers created when defining the infrastructure for the private cloud, move to the private cloud and run on the private cloud.

As part of stage four 208, the cloud creation computer system adds disaster recovery to the cloud, adds more service catalog definitions, and fully integrates the private cloud into the network. Also, the cloud creation computer system may use data gathered about the status of the private cloud to improve the performance of the private cloud. For example, common problems causing service interruptions may be addressed, fixed, or removed. Also, certain applications that perform poorly on the private cloud may be replaced with better suited applications.

Subsequently to integrating production applications, the cloud creation computer system integrates mission critical applications to the private cloud in stage five 210. The cloud creation computer system may evaluate the mission critical applications and transform them to be provided in the private cloud.

After moving mission critical applications, the cloud creation computer system may also install customizations and features to the fully implemented private cloud. Security features and disaster recovery features may be included. Also, more tenants may be added in each stage.

The exemplary embodiments can include one or more computer programs that embody the functions described herein and illustrated in the appended flow charts. However, it should be apparent that there could be many different ways of implementing aspects of the exemplary embodiments in computer programming, and these aspects should not be construed as limited to one set of computer instructions. Further, those skilled in the art will appreciate that one or more acts described herein may be performed by hardware, software, or a combination thereof, as may be embodied in one or more computing systems.

The functionality described herein can be implemented by numerous modules or components that can perform one or multiple functions. Each module or component can be executed by a computer, such as a server, having a non-transitory computer-readable medium and processor. In one alternative, multiple computers may be necessary to implement the functionality of one module or component.

Unless specifically stated otherwise as apparent from the following discussion, it is appreciated that throughout the description, discussions utilizing terms such as “processing,” or “computing” or “calculating” or “determining” or “displaying” or “generating” or “synchronizing” or “outputting” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The exemplary embodiments can relate to an apparatus for performing one or more of the functions described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions, and each coupled to a bus.

The exemplary embodiments described herein are described as software executed on at least one server, though it is understood that embodiments can be configured in other ways and retain functionality. The embodiments can be implemented on known devices such as a personal computer, a special purpose computer, cellular telephone, personal digital assistant (“PDA”), a digital camera, a digital tablet, an electronic gaming system, a programmed microprocessor or microcontroller and peripheral integrated circuit element(s), and ASIC or other integrated circuit, a digital signal processor, a hard-wired electronic or logic circuit such as a discrete element circuit, a programmable logic device such as a PLD, PLA, FPGA, PAL, or the like. In general, any device capable of implementing the processes described herein can be used to implement the systems and techniques according to this invention.

It is to be appreciated that the various components of the technology can be located at distant portions of a distributed network and/or the Internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine

Furthermore, it should be appreciated that the various links connecting the elements can be wired or wireless links, or any combination thereof, or any other known or later developed element(s) that is capable of supplying and/or communicating data to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

The embodiments described above are intended to be exemplary. One skilled in the art recognizes that numerous alternative components and embodiments that may be substituted for the particular examples described herein and still fall within the scope of the invention.

What is claimed is:

1. A method of introducing and acclimating an enterprise with a cloud comprising:
hosting, by a zero touch point computer system, a cloud by provisioning virtual machines using the resources of the zero touch point device with a cloud management environment;
installing, by a computer, the cloud on an enterprise server, wherein the cloud is accessible to a limited number of client computers through a network;
identifying, by a computer, all client computers connected to the enterprise server through the network;
evaluating, by a computer, an inventory of applications to be hosted by the enterprise server on the cloud;
defining, by a computer, application tiers for the evaluated applications, wherein the defined application tiers comprise a non-production application tier, a production application tier, and a mission critical application tier;
classifying, by a computer, the applications in the inventory of applications into the defined application tiers;
integrating, by a computer, at least one of the identified client computers to the cloud based on the evaluated applications of the enterprise server;
migrating, by a computer, at least one non-production application of the non-production application tier to the cloud;
integrating, by a computer, all the identified client computers to the cloud based on the evaluated applications of the enterprise server;
migrating, by a computer, at least one production application of the production application tier to the cloud; and
migrating, by a computer, at least one mission critical application of the mission critical application tier to the cloud.

2. The method of claim 1, wherein the zero touch point computer system is a portable computer system.

3. The method of claim 2, wherein the zero touch point computer system is preconfigured so that the cloud hosted by the zero touch point computer system requires no cloud configuration, installation, or deployment.

4. The method of claim 3, wherein the zero touch point computer system includes training and marketing videos that demonstrate features of the cloud.

5. The method of claim 1, wherein the cloud is a private cloud.

6. The method of claim 1, wherein the cloud is accessible to the limited number of client computers through the network for a trial period of a predetermined amount of time.

7. The method of claim 1, further comprising:
administering, by a computer, questionnaires the limited number of client computers before identifying all the client computers connected to the enterprise server through the network.

8. The method of claim 1, further comprising:
integrating, by a computer, the cloud with information technology service management after migrating production applications to the cloud.

9. The method of claim 1, wherein evaluating the inventory of applications comprises determining for each application in the inventory of applications at least one of virtualization requirements, storage requirements, service-level requirements, isolation and security requirements, network requirements, and capacity planning requirements.

10. The method of claim 1, further comprising:
gathering, by a computer, data about the status of the cloud;
reconfiguring, by a computer, the enterprise server based on the gathered data before migrating mission critical applications.

11. A method of introducing and acclimating an enterprise with a cloud comprising:
hosting, by a zero touch point computer system, a cloud by provisioning virtual machines using the resources of the zero touch point device with a cloud management environment;
installing, by a computer, the cloud on an enterprise server, wherein the cloud is accessible to a limited number of client computers through a network;
evaluating, by a computer, an inventory of applications to be hosted by the enterprise server on the cloud;
defining, by a computer, application tiers for the evaluated applications, wherein the defined application tiers comprise a non-production application tier, a production application tier, and a mission critical application tier;
classifying, by a computer, the applications in the inventory of applications into the defined application tiers;
migrating, by a computer, at least one non-production application of the non-production application tier to the cloud;
migrating, by a computer, at least one production application of the production application tier to the cloud; and
migrating, by a computer, at least one mission critical application of the mission critical application tier to the cloud.

12. The method of claim 11, wherein the zero touch point computer system is a portable computer system.

13. The method of claim 12, wherein the zero touch point computer system is preconfigured so that the cloud hosted by the zero touch point computer system requires no cloud configuration, installation, or deployment.

14. The method of claim 13, wherein the zero touch point computer system includes training and marketing videos that demonstrate features of the cloud.

15. The method of claim 11, wherein the cloud is a private cloud.

16. The method of claim 11, wherein the cloud is accessible to the limited number of client computers through the network for a trial period of a predetermined amount of time.

17. The method of claim 11, further comprising:
administering, by a computer, questionnaires to the limited number of client computers before defining the application tiers for the evaluated applications.

18. The method of claim 11, further comprising:
integrating, by a computer, the cloud with information technology service management after migrating production applications to the cloud.

19. The method of claim 11, wherein evaluating the inventory of applications comprises determining for each application in the inventory of applications at least one of: virtualization requirements, storage requirements, service-level requirements, isolation and security requirements, network requirements, and capacity planning requirements.

20. The method of claim 11, further comprising:
gathering, by a computer, data about the status of the cloud;
reconfiguring, by a computer, the enterprise server based on the gathered data before migrating mission critical applications.

21. A cloud system in an enterprise comprising:
a zero touch point device configured to host a first private cloud for demonstration purposes;
a cloud server connected to a plurality of client devices through a network configured to host a second private cloud, wherein the second private cloud is similar to the first private cloud and the second private cloud comprises more computing resources than the first private cloud; and
a cloud creation computer system connected to the cloud server configured to:
install the second private cloud on the cloud server;
identify all the client computers connected to the cloud server through the network;
evaluate an inventory of applications to be hosted by the cloud server on the second private cloud;
define application tiers for all of the discovered applications, wherein the defined application tiers comprise a non-production application tier, a production application tier, and a mission critical application tier;
classify the applications in the inventory of applications into the defined application tiers;
integrate at least one of the identified client computers to the cloud based on the evaluated applications of the cloud server;
migrate at least one non-production application of the non-production application tier to the second cloud;
migrate at least one production application of the production application tier to the second cloud; and
migrate at least one mission critical application of the mission critical application tier to the second cloud.
